(19) United States
(12) Patent Application Publication
(10) Pub. No.: US 2004/0187372 A1
(43) Pub. Date: Sep. 30, 2004

(54) Combined storage device with integrated advertising medium

(76) Inventor: Peter Dorizas, Killamey Heights (AU)

Correspondence Address: JONES DAY, 555 WEST FIFTH STREET, SUITE 4600, LOS ANGELES, CA, 90013-1025, US

(21) Appl. No.: 10/483,787

(22) PCT Filed: Jul. 10, 2002
(86) PCT No.: PCT/AU02/00928

(30) Foreign Application Priority Data
Jul. 11, 2001 (AU) PR 6258

(51) Int. Cl. G09F 3/18

(52) U.S. Cl. 40/661

(57) ABSTRACT

A storage device (10) to hold and protect sheets of paper, cards, photographs and other flat items, while also providing a medium for advertising to the end user. More specifically the invention relates to both; the combination of two different flexible materials (12, 14) in their arrangement which makes an individual pocket (10) and creating an apparatus that has especially designed extended rear for displaying a visual message (15) and/or information. In most situations this indicia (15) would be of a promotional and/or advertising nature. The front (12) of the pocket is made from a thin transparent plastic that allows you to see the contents of the pocket while the rear (14) is of a thicker opaque flexible material. The design and materials allow for high-speed printing while remaining a flexible product that can be repositioned without damage. There are multiple methods of attachment, via the back of the rear panel (14), to the vertical surfaces.

This invention relates to improvements in storage devices usually used for holding and/or protecting sheets of paper, card, photographs and other flat items. However it is to be understood that the invention has broader applications for holding other items for display, easy access, and protection while also being used as an advertising medium.

Additional functions of these storage devices are; to be able to fix or attach to a vertical surface and hang down in a relatively flat manner and to be able to provide a message on the extension of the rear wall of the storage/pocket device. This message/indicia is always visible even when there are items stored inside the pocket.

A scenario that clearly illustrates the use of the pockets relates to when an extra large A4 version of the pockets, is attached to a parent's refrigerator door with the school newsletters inside. While the newsletters are always visible they are kept together and protected as well as there being a promotional message from the school, printed on the pocket above the opening and it is also always visible.

This invention is particularly concerned with the need to print the indicia by using high-speed machinery and to do so as part of the early stage of the pockets' manufacturing. This relates to the situation where the pockets are required more for the abilities of advertising and promotional reasons than for simply storing items.

While each functional aspect is individually important, the combination of the solutions/aspects makes this invention novel. The various current pockets that are available do not provide all the aspects as in the new system.

The majority of flexible holder/protector pocket devices, which are currently available for the purpose to store and protect, have no provision for suspending the device in a vertical manner by some form of fixing/attaching at the top to while still allowing easy access to the opening to the pocket. Furthermore, none of these are able to carry indicia at the top of the device above the opening to the pocket or pockets.

Some of these devices have an extension on a side, which allows the edge to be placed in “ringbound” folders or similar booklets. They do not allow the pocket to be attached at the top by an integral part of the pocket and hung in a vertical manner to provide clear and complete display of the information while the pocket opening allows easy access during loading and unloading.

Other types of storage devices/pockets that are designed to be suspended perform some of the required functions but also have problems in satisfying other aspects. One example of this is specific custom-made soft vinyl pockets which generally have the correct shape and you can add a method of fixing but the vinyl will distort overtime, may react with the store item and is not suitable for most types of high speed printing processes. The vinyl is not considered environmentally friendly. Another example is the various thin plastic bags that also have printed information on them yet they do not have their own integrated method of fixing to a vertical surface and do not retain the flat form but then tend to sag and distort the contents.

Another current example is the display devices for merchandising, which have a cardboard and/or cardboard plus, coated back with the clear plastic front. These storage devices are generally not suitable for the function of continuously inserting and removing the stored items. They also are not flexible enough to allow for constant repositioning on a vertical surface.

Therefore the important functions of the new invention is to provide a pocket that can display content while still being able to keep its shape overtime, have an opaque rear material—rigid enough to restrict sagging yet not to thick to not be flexible. It must be strong enough to be able to have holes punch into it (if required) and not be easily torn or distorted due to the vertical weight.

The rear material must be appropriate for a range of high speed printing methods including where appropriate digital printing. It must be compatible with the front material so that they can be welded, sealed, glue, on the bottom and or sides.

Another object of the invention is to have the rear material provide for a suitable surface to absorb and not react to adhesive that are on magnets, labels, and stickers. These items need to adhere to the front and/or rear to perform their specific task and allow the rear of the plastic pocket to be easily lifted off and returned without tearing or distorting yet the fixing to the rear is strong enough to hold the device to the surface.

The clear front must not react with the material store inside such as does the PVC (vinyl).

In an attempt to overcome at least some of the disadvantages of the prior art, the invention, in one broad form, provides a storage system comprising: at least one pocket having front and rear walls, a top, a bottom and an opening adjacent the top of the front wall between the front and rear walls,

a new combination of plastic materials, with the front of the pocket being a transparent inert/acid free plastic and the preferred option for the rear an opaque synthetic plastic paper and

securing means for securing the at least one pocket to an object with the opening above the bottom without substantially impeding access to the opening.

Preferably the securing means comprises at least part of the rear wall of the each pocket.

The rear wall of the pocket (including the extension) and the method of attachment may be integrated into one single composite sheet material. The rear wall of each pocket extends above the opening and adhesive material is provided to secure the pocket to a vertical surface.

The adhesive material may be integrated with or bonded to the rear wall. Preferably the adhesive material is a strip, which is bonded to the rear of the extension of the rear wall.

The adhesive material may extend over all or part of the rear wall, as double-sided tape. In one form of the invention the pocket may be made with the top extension above the opening having a magnetic strip permanently attached to the rear of it. This would allow the pocket to hang freely in front of a metal surface and be easily moved it required.

The preferred material for the transparent front is 50-100 microns of a plastic similar to cast polypropylene. The rear has a thicker opaque material and must be capable of receiving writing or indicia, especially high speed printing, with this aspect creating an advertising medium.

The preferred material for the rear is some form of synthetic plastic paper with such material being made by different methods and base materials, such as those know as: synthetic polypropylene film (made by a calendering machine), or compressed 100% high density polyethylene fibres, or nylon film or 2-side coated pigmented high density polyethylene film, or a single layer/micro porous/uncoated/ highly filled/polyolefin film, or 3-ply biaxially oriented polypropylene film, or corona treated cast polypropylene.

In one form of the invention the rear synthetic plastic paper is pre-printed in a roll form prior to being joined together with the clear, which is also in roll form.

In one embodiment the rear synthetic plastic paper, after printing may be cut to shape before being joined with the clear front rolls of film.

Another process may be that both materials for the front and rear, after starting as rolls and/or larger sheets are precut to the smaller required panel sizes prior to forming the pockets.

The section to the top is to be proportionally 17% of the front clear (as a minimum) to allow for a substantial area for printing above the opening.

In other forms the method of attaching the pocket to a surface may be by adhesive foam, or hook and loop fastener material or other adhesive substance. Another method of attachment would be a plastic fastening device that would comprise of first and second profiles (similar to Velcro) that interlock and one of the profiles attaches to another surface other than the pocket.

In another form the top of the extension maybe simply placed into an independent clamp, clip etc.

In another form the top extension may initially and or have added to it, holes to allow for attachment of the top to an appropriate device.

The invention shall be better understood from the following non-limiting description of embodiments of the invention and the drawings, in which:

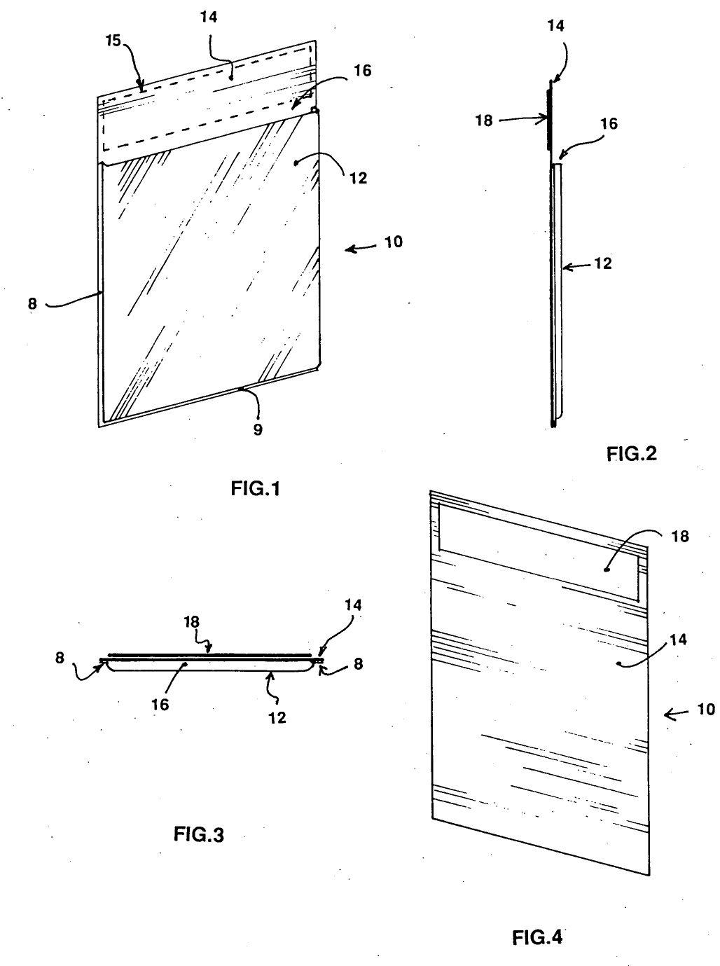

FIG. 1 shows a perspective view of a first embodiment of the invention

FIG. 2 shows a side view of the FIG. 1 embodiment.

FIG. 3 shows a plan view of the FIG. 1 embodiment

FIG. 4 shows a rear view of the FIG. 1 embodiment of the invention.

FIG. 5 shows a perspective view during manufacturing where the rear section is individual rectangular shapes of cut sheets of plastic while the front is still in a roll form.

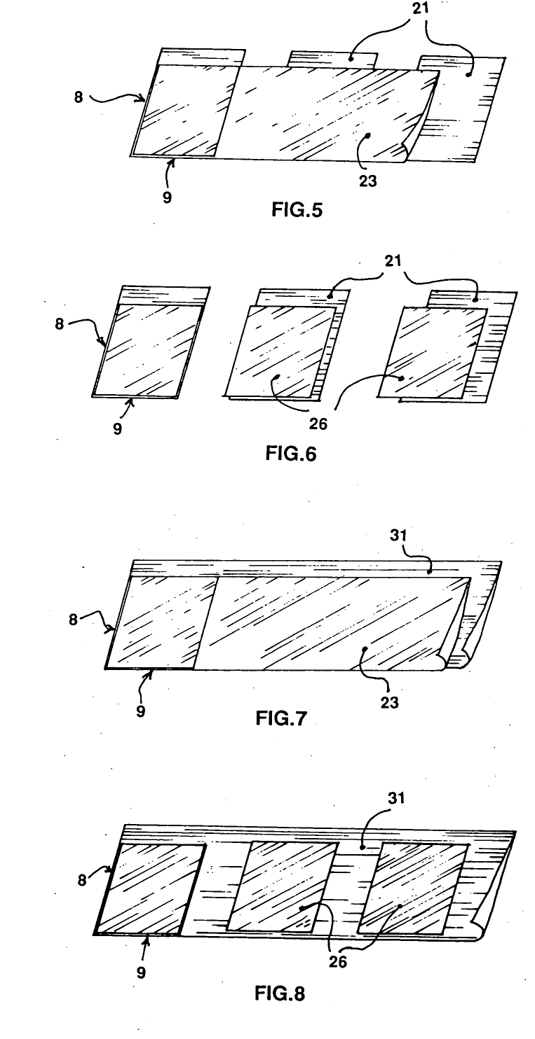

FIG. 6 shows a perspective view during manufacturing where the rear and front sections are both individual rectangular shapes.

FIG. 7 shows a perspective view that during manufacturing both the front and rear are in the roll form prior to welding.

FIG. 8 shows a perspective during manufacture where the rear is in a roll form and the front clear is in the cut sheet form prior to welding.

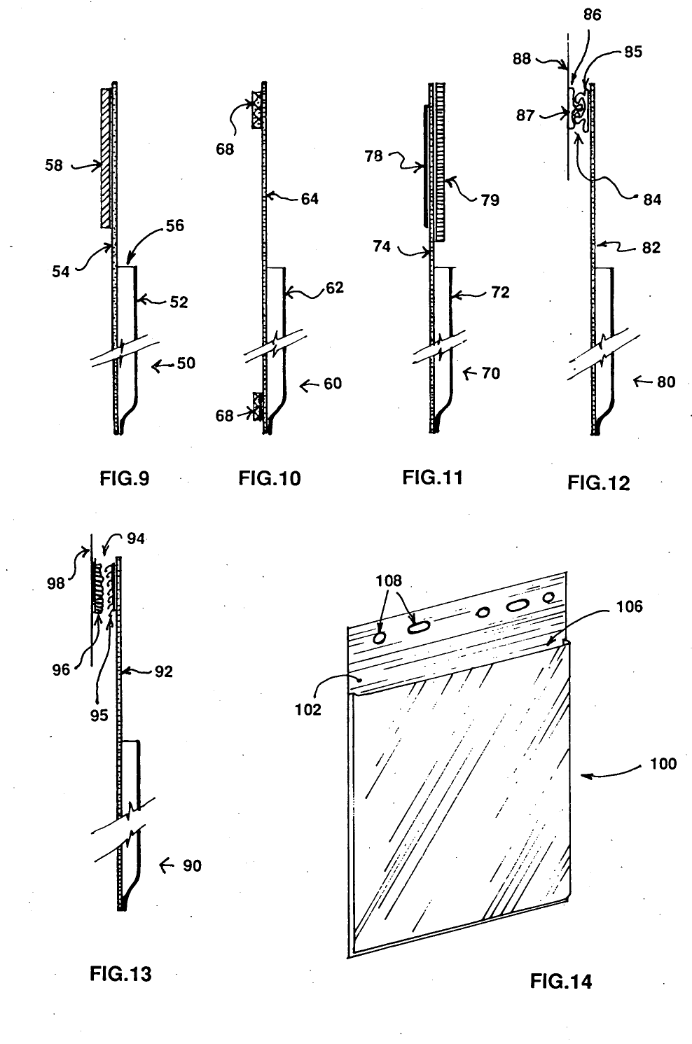

FIGS. 9 TO 13 are sectional views of various embodiments of the invention.

FIG. 14 shows a perspective view of a further embodiment of the invention.

In the drawings, the thickness of the components has been increased in comparison to the other dimensions and it will be appreciated that the actual thickness of the components is much less than shown in the drawings.

Referring to FIGS. 1, 2, 3 and 4; there is shown a first embodiment of the invention, comprising a pocket 10.

The pocket comprises a front wall 12 and a rear wall 14. The front and rear walls 12, 14 are joined at the base 9 and sides 8 to form a pocket open at its upper end, with an opening 16 via which articles may be placed in the pocket. Preferably the front and rear walls 12, 14 are formed by a sheet of transparent plastics material 12 welded at the base and the sides to an opaque plastic material 14.

The rear wall 14 extends upwards beyond the opening 16 creating an area for indicia 15, such that the pocket is an advertising medium. A double-sided adhesive tape 18 is laminated to the rear face of the rear wall 14. The strip 18 extends the full width of the rear wall 14 and substantially the full height above the opening 16. However, depending on the adhesive strength of the strip 18 and the intended use of the pocket, the strip 18 may be of lesser or greater extent than the free portion of wall 14. A thicker glue substance that has a removable covering may replace the double-sided adhesive tape 18.

FIG. 5, 6, 7, and 8 illustrate various manufacturing alternatives to achieve the final pocket structure when combining the front and rear materials. With FIG. 5 the rear shapes 21 are precut prior to coming together with the clear front 23. The rear shapes 21 can also be matched with precut fronts 26, as per FIG. 6. In FIG. 7, both the rear 31 and the front 23 are in a roll form. The front piece 26 meets a rear continuous roll 31 as shown in FIG. 8.

For clarity we have not shown any printed information on the rear pieces 21 or the roll version 31. It should also be noted, that in any or all of the manufacturing options shown, the front and rear can be flipped over, with the front under the rear. These options also only represent part of the whole manufacturing process.

FIG. 9 shows a further embodiment of the invention, 50. In this embodiment the pocket is formed as with the previous embodiments and the rear wall 54 extends above the front wall 52. A magnetic strip 58 is secured to the rear face of the rear wall 54. The strip is about one half the height of the free portion of wall 54 and is secured adjacent the top edge. In use the pocket may be attached to a magnetic surface usually a vertical surface, such as a refrigerator door or similar with the opening 56 facing upwards.

FIGS. 10 and 11 show two embodiments intended for more permanent fixing compared to the FIGS. 1-4 and 9 embodiments.

In the FIG. 10 embodiment 60, the rear wall 64 extends above the opening and an adhesive substance 68 is provided on several locations of the rear face of the rear wall. The adhesive may extend over the entire rear surface of rear wall 64 or depending on the strength of the adhesive and the intended load, or only a portion of the wall 64. As shown in FIG. 10, preferably there is adhesive 68 on the extension of the rear wall, in discreet patches.

Optionally, the front surface of the rear wall 64 may receive writing or, as shown in FIG. 11, a separate piece of material 79 may be attached to the front surface of the free portion for the purpose of carrying writing or indicia. This additional material 79 may be laminated to the rear wall or secured by way of suitable adhesive. It will be appreciated also that a separate piece of material 79 for receiving writing, printing or the like may be used with the other embodiments of the invention.

FIG. 12 shows a further version 80 in which the securing means 84 comprises first and second interlocking portions 85 and 86. First portion 85 is secured adjacent the top edge of rear wall 82, preferably by adhesive, whilst the second portion 86 is provided with an adhesive 87 for attachment to a vertical surface 88. The first and second portions are in the nature of an elongate strip extending across all or part of the width of the device.

FIG. 13 shows a variation of the FIG. 12 device, in which the securing means 94, comprises hook and loop fastener material. The portion 95 secured to the rear wall 92 is preferably secured with adhesive, but may be secured by stitching. The other portion 96 is preferably provided with adhesive for securing to the surface 98.

FIG. 14 shows a further variation of the invention, in which the pocket 100 has a plain rear wall 102 extending above the opening 106. The rear wall 102 is provided with a series of holes, 108 extending across its width adjacent the upper edge. The holes may be circular or oval, so as to enable the pocket 100 to be hung from hooks or similar devices provided at various spacings.

The invention is not limited to the method of joining the two plastics together. There are many possible ways, which include, but are not limited to, impulse heat sealing, die welding, ultra sonic welding, high frequency welding and hot or cold laminating.

It will be appreciated that many modifications and variations may be made to the embodiments described herein by those skilled in the art without departing from the spirit or scope of the invention.

1. (Original): A storage device for holding and protecting sheets of paper, card photographs and other flat items, comprising;
a combination of flexible front and rear panels of different plastics which may be described as a pocket,
the front panel is made from an inert acid-free transparent thin plastic film such as polypropylene,
the rear panel is made from a thicker opaque synthetic plastic paper which has different chemical structure to the front, with this preferred material being suitable for high speed printing,
the rear panel is of a greater height at the top, than the clear front panel,
the pocket is formed by sealing the two sides and the bottom of the front panel to the rear panel while the top of the front is not sealed creating an opening, which has the extended rear proportion above it,
the rear panel has the ability to have indica or writing on it and located above the opening and
to the back of the rear panel in an adhesive substance to allow the pocket to attach to a vertical surface.

2. (Original): A pocket according to claim 1 wherein,
the most common technical names for the synthetic plastic paper rear panel include, although not limited to, synthetic polypropylene film (made by calendering machine), or compresses 100% high density polyethylene fibres, or nylon film, or 2-side coated pigmented high density polyethylene film, or a single layer/microporous/uncoated/highly filled/polyolefin film, or 3-ply biaxially orientated polypropylene film, or corona treated polypropylene.

3. (Original): A pocket according to claim 1 wherein,
the method of attachment to a vertical surface includes magnets.

4. (Original): A pocket according to claim 1 wherein,
the method of attachment can be other known materials such as adhesive tape, Velcro, adhesive foam.

5. (Original): A pocket according to claim 1 wherein,
the synthetic plastic paper allows a stable bonding between itself and the method of attachment.

6. (Original): A pocket according to claim 1 wherein,
the method of attachment will be provided by another independent product such as a hook, a pin or a clip to the extension of the rear panel, while still providing unrestricted access to the opening.

7. (Original): A pocket according to claim 1 wherein,
the indicia or writing may or may not be describing or relating to anything stored within the pocket below.

8. (Original): A pocket according to claim 1 wherein,
the extension to the rear is a minimum of 17% of the height of the front panel.

9. (Original): A pocket according to claim 1 wherein,
the method of attachment are placed in several locations on the back of the rear panel, thus permitting the pocket to be positioned at 90 degrees such that the rear extension would be on the left or right hand side of the pocket which would now have a horizontal orientation.

10. (Original): A pocket according to claim 1 wherein,
the intermediate product is made by a manufacturing process which can be by using either two rolls of material for the front and rear panels, or two separate precut panels, or one roll and one separate precut panel.

11. (Original): An apparatus for providing indica for advertising to a vertical surface, comprising,
a combination of flexible front and rear panels of two different plastics which may be described as a pocket,
the front panel is made from an inert acid-free transparent thin plastic film such as polypropylene,
the rear panel is made from a thicker opaque synthetic plastic paper which has a different chemical structure to the front, with this preferred material being suitable for high speed printing,
the rear panel is of a greater height at the top, than the clear front panel,
the pocket is formed by sealing the two sides and the bottom of the front panel to the rear panel while the top of the front is not sealed creating an unobstructed opening, which has the extended rear proportion above it,
the rear panel has the ability to have indica or writing on it for advertising and/or promotional purposes and this area is located above the opening and
to the back of the rear panel in an adhesive substance to allow the pocket to attach to a vertical surface.

12. (Original): A pocket according to claim 11 wherein,
the most common technical names for the rear panel included, although not limited to, synthetic polypropylene film (made by calendering machine), or compresses 100% high density polyethylene fibres, or nylon film, or 2-side coated pigmented high density polyethylene film, or a single layer/microporous/uncoated/highly filled/polyolefin film, or 3-ply biaxially orientated polypropylene film, or corona treated polypropylene.

13. (Original): A pocket according to claim 11 wherein,
the method of attachment to a vertical surface includes magnets.

14. (Original): A pocket according to claim 11 wherein,
the method of attachment can be other known materials such as adhesive tape, Velcro, adhesive foam.

15. (Original): A pocket according to claim 11 wherein,
the synthetic plastic paper allows a stable bonding between itself and the method of attachment.

16. (Original): A pocket according to claim 11 wherein,
the method of attachment will be provided by another independent product such as a hook, a pin or a clip to the extension of the rear panel, and still providing unrestricted access to the opening.

17. (Original): A pocket according to claim 11 wherein,
the indicia or writing may or may not be describing or relating to anything stored within the pocket below.

18. (Original): A pocket according to claim 11 wherein,
the extension to the rear is a minimum of 17% of the height of the front panel.

19. (Original): A pocket according to claim 11 wherein,
the method of attachment are placed in several locations on the back of the rear panel, thus permitting the pocket to be positioned at 90 degrees such that the rear extension would be on the left or right hand side of the pocket which would now have a horizontal orientation. Preliminary Amendment dated Jan. 12, 2004.

20. (Original): A pocket according to claim 11 wherein,
the intermediate product is made by a manufacturing process which can be by using either two rolls of material for the front and rear, or two separate precut panels, or one roll material and a separate precut panel.

21. (New): A storage device comprising:
a rear panel;
a front panel attached along portions of its outer edges to said rear panel thereby forming a pocket with an opening on one side;
said front panel further comprising a flexible material made of transparent plastic film;
said rear panel further comprising:
a flexible and opaque synthetic plastic paper having a different chemical structure from the front panel, said synthetic plastic paper further having a chemical structure that allows printing through the use of a high speed printing machine;
a bottom surface;
a top planar surface facing opposite said bottom planar surface, wherein said bottom planar surface further secures said storage device to a non-horizontal surface while providing unrestricted access to said pocket; and
an exposed area on the top planar surface that is not covered by the front panel such that indicia made on said exposed area is visible while materials are inside said pocket.

22. (New): The storage device of claim 21, wherein said exposed area encompasses a surface area that is at least 17% of the surface area of the front panel.

23. (New): The storage device of claim 21, wherein said exposed area of the rear panel provides a location for indicia to be placed and viewed while materials are within said pocket.

24. (New): The storage device of claim 21, wherein said rear panel is made of a substance selected from the group consisting of 1) synthetic polypropylene film made by a calendering machine, 2) compressed 100% high density polyethylene fibres, 3) nylon film, 4) 2-side coated pigmented high density polyethylene film, 5) a single layer/microporous/uncoated/highly filled/polyolefin film, 6) 3-ply biaxially orientated polypropylene film, or 7) corona treated polypropylene.

25. (New): The storage device of claim 21, wherein said rear panel is attached to a non-horizontal surface with a magnet.

26. (New): The storage device of claim 25, wherein said magnet is attached to the bottom planar surface of said rear panel.

27. (New): The storage device of claim 21, wherein said rear panel includes a hole configured to receive a protruding article from a non-horizontal surface, and wherein the rear panel's hole is located away from the pocket opening thereby permitting access to the pocket opening.

28. (New): The storage device of claim 21, wherein a bonding material attaches the storage device to a non-horizontal surface, wherein said bonding material is selected from the group consisting of a chemical adhesive, double sided tape, adhesive foam, or Velcro.

29. (New): A storage device comprising:
a rear panel;
a front panel attached along portions of its outer edges to said rear panel thereby forming a pocket with an opening on one side;
said front panel further comprising a flexible material made of transparent plastic film;
said rear panel further comprising:
a flexible and opaque synthetic plastic paper having a different chemical structure from the front panel, said synthetic plastic paper further having a chemical structure that allows printing through the use of a high speed printing machine;
a bottom surface;
a top planar surface facing opposite said bottom planar surface, wherein said bottom planar surface includes a bonding material on said bottom planar surface that secures said storage device to a non-horizontal surface while providing unrestricted access to said pocket, and wherein said bonding material is selected from the group consisting of a chemical adhesive, double sided tape, adhesive foam, or Velcro;
an exposed area on the top planar surface that is not covered by the front panel such that indicia made on said exposed area is visible while materials are inside said pocket; and
wherein said exposed area includes a hole configured to receive a protruding article from a non-horizontal surface, wherein the rear panel's hole is located away from the pocket opening thereby permitting access to the pocket opening.
